(19) United States
(12) Patent Application Publication
(10) Pub. No.: US 2016/0209961 A1
(43) Pub. Date: Jul. 21, 2016

(54) TOUCH SENSOR

(71) Applicant: ELECTRONICS AND TELECOMMUNICATIONS RESEARCH INSTITUTE, Daejeon (KR)

(72) Inventor: Chang Geun AHN, Daejeon (KR)

(21) Appl. No.: 14/996,593

(22) Filed: Jan. 15, 2016

(30) Foreign Application Priority Data
Jan. 15, 2015 (KR) 10-2015-0007543
Jan. 4, 2016 (KR) 10-2016-0000383

(51) Int. Cl. G06F 3/044

(52) U.S. Cl. CPC G06F 3/044; G06F 2203/04103

(57) ABSTRACT

Provided herein is a touch sensor for sensing a touch of a user. The touch sensor includes a first electrode, a second electrode facing the first electrode, at least one piezoelectric element disposed between the first electrode and the second electrode, and electrode pads coupled to the first electrode.

### CROSS-REFERENCE TO RELATED APPLICATION

The present application claims priority to Korean Patent Application Numbers 10-2015-0007543 filed on Jan. 15, 2015 and 10-2016-0000383 filed on Jan. 4, 2016, in the Korean Intellectual Property Office, the entire disclosure of which is incorporated by reference herein.

### BACKGROUND

1. Field of Disclosure

Various embodiments of the present disclosure relate to a touch sensor, and more particularly, to a touch sensor configured to sense a touch of a user using a piezoelectric element and a resistive film.

2. Description of Related Art

Touch sensors that have been hitherto introduced aim to obtain information about the location of a touch point. However, to enhance touch sensitivity and make realistic expression possible, there is need for obtaining information about the intensity of the touch along with the location information.

Technologies which are being most widely used for touch panels include a capacitance touch panel technology and a resistive touch panel technology. Since it is difficult in principle to recognize the intensity of a touch in both these two kinds of methods, other various methods have been proposed. Methods combined with the two kinds of existing methods have also been introduced. However, most of these conventional methods are technologies which require highly complex structures or have low feasibility.

### SUMMARY

Various embodiments of the present disclosure are directed to a touch sensor which is able to determine the location of a point at which a touch of a human body or an object is made and the intensity of the touch.

One embodiment of the present disclosure provides a touch sensor configured to sense a touch of a user, including: a first electrode; a second electrode facing the first electrode; at least one piezoelectric element disposed between the first electrode and the second electrode; and electrode pads coupled to the first electrode.

In an embodiment of the present disclosure, the touch sensor may further include a sensing unit coupled to the first electrode and the second electrode and configured to sense a voltage change by the piezoelectric element when a touch of the user is made.

In an embodiment of the present disclosure, the first electrode may have a rectangular shape including first to fourth sides. The first and third sides may extend in an x-axis direction, and the second and fourth sides may extend in a y-axis direction.

In an embodiment of the present disclosure, the electrode pads may comprise three electrode pads. The electrode pads may include: an origin electrode pad provided on one of corners of the first electrode; an x electrode pad disposed at a position spaced apart from the origin electrode pad in the x-axis direction; and a y electrode pad disposed at a position spaced apart from the origin electrode pad in the y-axis direction.

In an embodiment of the present disclosure, the electrode pads may be arranged in another shape. The electrode pads may include first electrode pads arranged on the first side of the first electrode in the x-axis direction, and second electrode pads arranged on the second side of the first electrode in the y-axis direction.

In an embodiment of the present disclosure, the piezoelectric element may be provided to have an integrated structure and comprise a plurality of piezoelectric elements. In the case where a plurality of piezoelectric elements are provided, the piezoelectric elements may be arranged in a matrix having the x-axis direction as a row direction and the y-axis direction as a column direction.

In an embodiment of the present disclosure, the first electrode pads are provided to one-to-one correspond to the columns of the matrix, and the second electrode pads may be provided to one-to-one correspond to the rows of the matrix.

In an embodiment of the present disclosure, the electrode pads may further include third electrode pads provided on the third side facing the first side. The third electrode pads may be provided to one-to-one correspond to the columns of the matrix. The electrode pads may further include fourth electrode pads provided on the fourth side facing the second side. The fourth electrode pads may be provided to one-to-one correspond to the rows of the matrix.

In an embodiment of the present disclosure, the piezoelectric element may include piezoelectric polymer material. The piezoelectric polymer material may be polyvilylidenefluoride or a derivative thereof.

In an embodiment of the present disclosure, each of the first electrode and the second electrode may be made of a transparent metal oxide film.

In an embodiment of the present disclosure, the touch sensor may be used in a display. In this case the touch sensor may be provided on a front surface of the display that displays an image thereon.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1A is an exploded perspective view illustrating a touch sensor having a single piezoelectric element according to an embodiment of the present disclosure;

FIG. 1B is an exploded perspective view illustrating a touch sensor having electrode pads array according to an embodiment of the present disclosure;

FIG. 1C is an exploded perspective view illustrating a touch sensor having a plurality of piezoelectric elements according to an embodiment of the present disclosure;

FIG. 2A is a plan view illustrating the touch sensor according to an embodiment of the present disclosure;

FIG. 2B is a sectional view taken along line I-I′ of FIG. 2A;

FIG. 2C is a sectional view taken along line II-II′ of FIG. 2A;

FIGS. 3A and 3B are conceptual views illustrating the principle of sensing the location and/or intensity of a touch of a user for the touch sensor according to an embodiment of the present disclosure;

FIG. 4 is a plan view illustrating a touch sensor according to another embodiment of the present disclosure;

FIG. 5 is a schematic equivalent circuit diagram of the touch sensor of FIG. 4;

FIG. 6 is a sectional view illustrating a touch sensor with two additional base substrates according to an embodiment of the present disclosure; and

FIG. 7 is a sectional view illustrating a display using a touch sensor according to an embodiment of the present disclosure.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Reference will not be made in detail to various embodiments of the present disclosure, specific examples of which are illustrated in the accompanying drawings and described below, since the embodiments of the present disclosure can be variously modified in many different forms. However, it is to be understood that the present description is not intended to limit the present disclosure to those exemplary embodiments, and the present disclosure is intended to cover not only the exemplary embodiments, but also various alternatives, modifications, equivalents and other embodiments that fall within the spirit and scope of the present disclosure.

Throughout the disclosure, like reference numerals refer to like parts throughout the various figures and embodiments of the present disclosure. The sizes of elements in the drawings may be exaggerated for clarity of illustration. It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element. In the present disclosure, the singular forms are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof. Furthermore, when a first part such as a layer, a film, a region, or a plate is on a second part, the second part may be not only directly on the first part but a third part may intervene between them. Furthermore, when it is expressed that a first part such as a layer, a film, a region, or a plate is formed on a second part, the surface of the second part on which the first part is formed is not limited to an upper surface of the second part but may include other surfaces such as a side surface or a lower surface of the second part. To the contrary, when a first part such as a layer, a film, a region, or a plate is under a second part, the second part may be not only directly under the first part but a third part may intervene between them.

Exemplary embodiments of the present disclosure will hereinafter be described in detail with reference to the accompanying drawings.

An embodiment of the present disclosure relates to a touch sensor that is a device, which may sense the location and/or intensity of a touch of a user inputted by the hand of a user, a stylus, or other separate input inputs, and display or transmit information corresponding to the touch. The touch sensor may be used in various devices and, particularly, used in a display so as to sense a touch of the user.

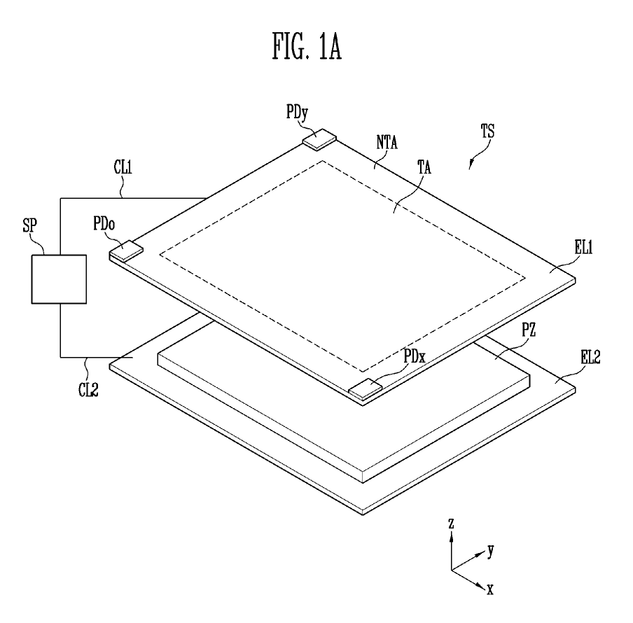

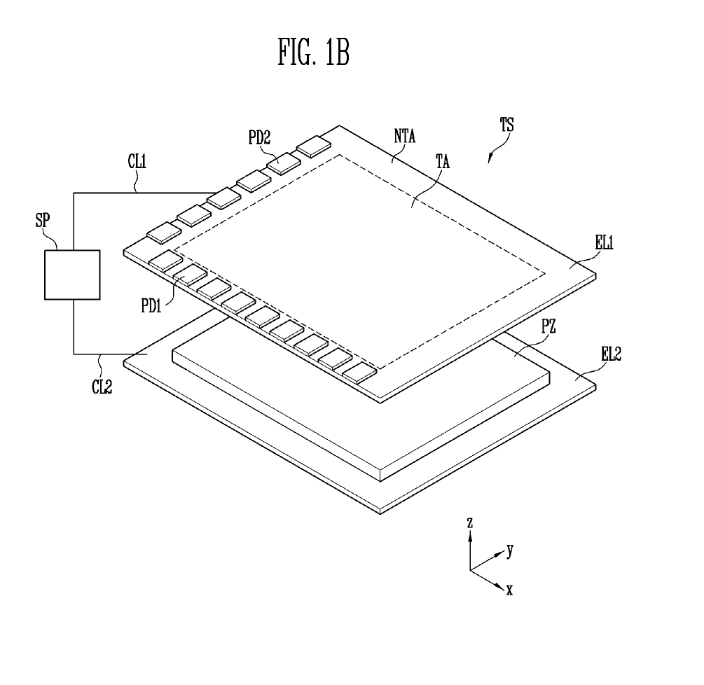

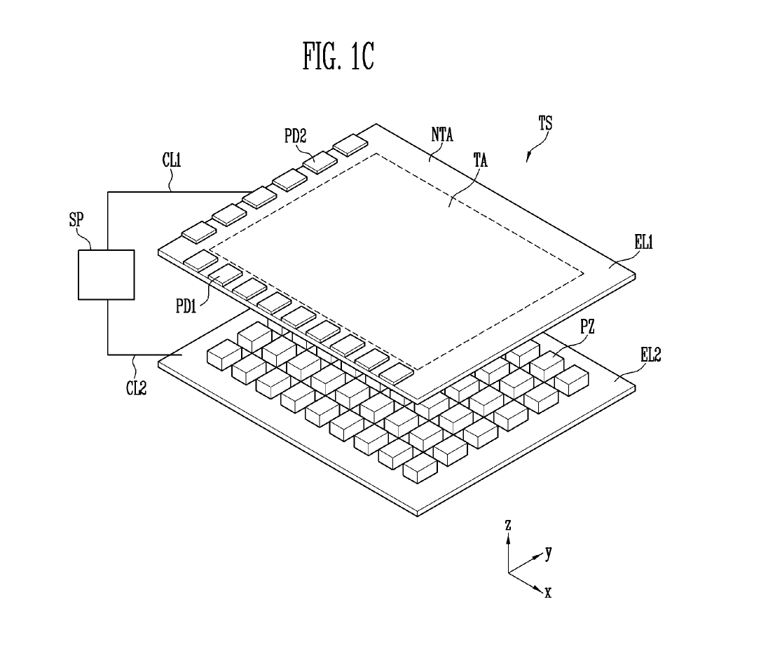

FIGS. 1A to 1C are perspective views illustrating a touch sensor according to an embodiment of the present disclosure.

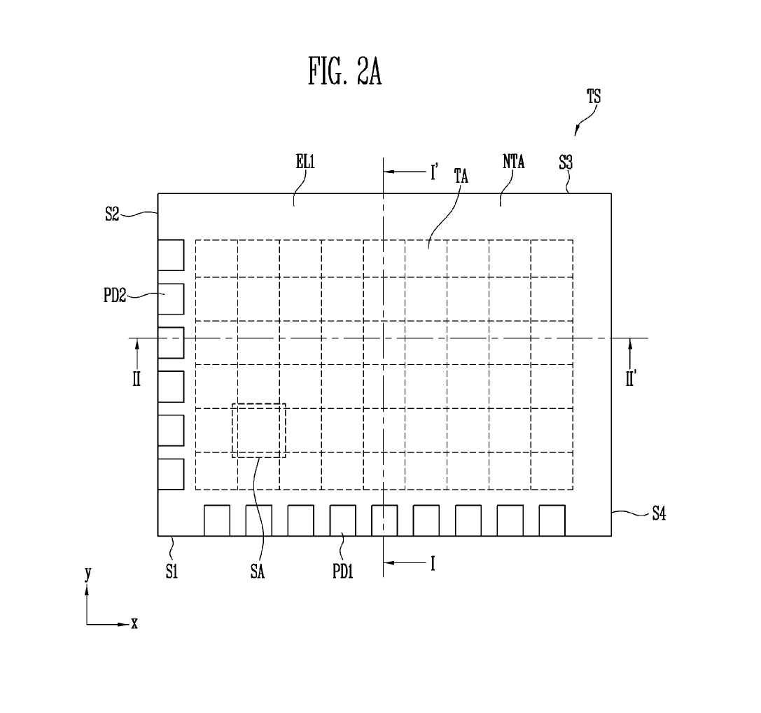

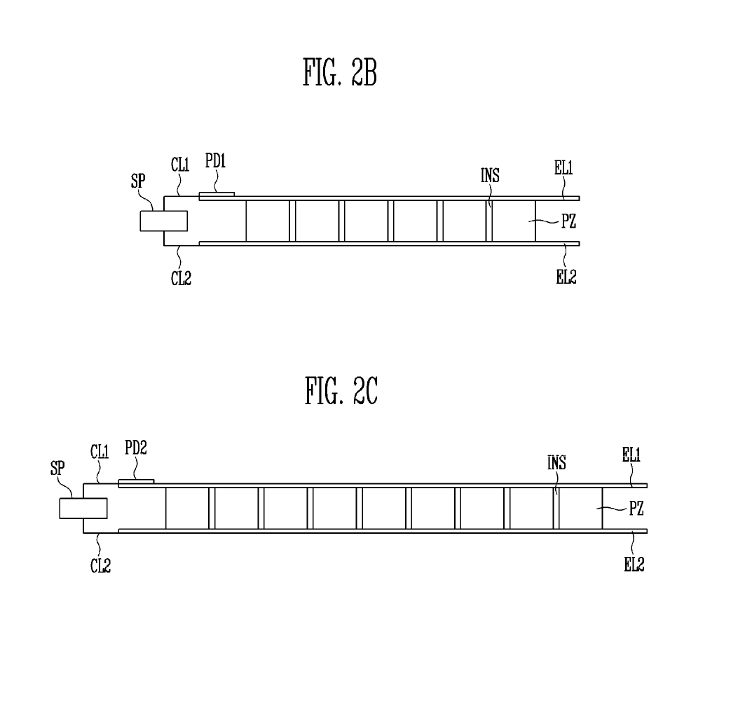

FIG. 2A is a plan view of a touch sensor according to an embodiment of the present disclosure, corresponding to the touch sensor of FIG. 1C. FIG. 2B is a sectional view taken along line I-I′ of FIG. 2A. FIG. 2C is a sectional view taken along line II-II′ of FIG. 2A.

Referring to FIGS. 1A to 1C and 2A to 2C, the touch sensor TS according to an embodiment of the present disclosure may include a first electrode EL1, a second electrode EL2, at least one piezoelectric element PZ, and electrode pads.

The touch sensor TS may include a touch region TA and a non-touch region NTA which is provided on at least one side of the touch area TA. The touch region TA may be a region on which a touch of a user is made. The non-touch region NTA may be a region on which a touch of the user is not made, or which does not sense whether a touch is made even when the touch of the user is made.

The touch region TA may include a plurality of sensing regions SA. Each sensing region SA may be the smallest unit for sensing the touch of the user. That is, when the touch of the user is present, at least one sensing region SA is involved in determining whether the touch of the user is made, and the intensity of the touch. For example, one sensing region SA may sense the touch of the user or, alternatively, a plurality of sensing regions SA may sense the touch of the user. As needed, the area of each sensing region SA and the number of sensing regions SA may be changed in various ways. For instance, when delicate touch recognition is required, the area of each sensing region SA may be reduced while the number of sensing regions SA may be increased. In a plan view, the sensing regions SA may be arranged in various forms depending on the shape of a region which is intended to sense the touch of the user. In the embodiment of the present disclosure, as an example, it is illustrated that the sensing regions SA are arranged in a form of a matrix including a row extending in the x-axis direction and a column extending in the y-axis direction. Here, the z-axis may extend in a direction, which is perpendicular to the x-axis and the y-axis, and in which the user is located.

In the embodiment of the present disclosure, the first electrode EL1 may be an electrode which is provided to a user side and corresponds to a surface that the user touches.

The first electrode EL1 may be applied with no voltage. When a touch is made on the first electrode EL1, a voltage generated from the piezoelectric element PZ which will be explained later herein may be applied thereto.

The first electrode EL1 may cover the entirety of the touch region TA and extend to the non-touch region NTA. In a plan view, the first electrode EL1 may have various forms depending on the shape of the touch region TA, which is intended to recognize the touch of the user. For example, in the embodiment of the present disclosure, the first electrode EL1 may have a rectangular shape including first to fourth sides S1, S2, S3, and S4. The first and third sides S1 and S3 may be parallel sides which extend in the x-axis direction and face each other. The second and fourth sides S2 and S4 may be parallel sides which extend in the y-axis direction and face each other. However, the shape of the first electrode EL1 is not limited to this. For example, the first electrode EL1 may have various shapes including circular, elliptical, triangular, and pentagonal shapes, etc. In the embodiment of the present disclosure, the first electrode EL1 having a rectangular shape will be described as an example.

The first electrode EL1 may be formed of conductive material. The first electrode EL1 may be an electrode having a predetermined resistance, and be formed of various kinds of material. The first electrode EL1 may be formed of conductive material, for example, metal, a metal oxide, a conductive polymer, and so forth. The material of the first electrode EL1 may be changed in various ways depending on the kind of device employing the touch sensor TS. For example, when the touch sensor TS is employed in a display, the first electrode EL1 may be made of transparent material.

In the embodiment of the present disclosure, the first electrode EL1 may be particularly made of a metal oxide. The metal oxide may be an indium tin oxide (ITO), an indium zinc oxide (IZO), a tin antinomy oxide (TAO), a tin oxide (TO), a zinc oxide (ZnO), etc.

In another embodiment of the present disclosure, the first electrode EL1 may be made of a conductive polymer. As the conductive polymer, a polymer such as polythiophene, polypyrrole, polyaniline, polyacetylene, or polyphenlyene may be used. Particularly, a conductive polymer used for the first electrode EL1 may be poly-3, 4-ethylenedioxythiophene/polystyrene sulfonate (PEDOT/PSS). However, the material of the first electrode EL1 is not limited to this. A mixture of one or more kinds of polymeric compounds having conductivity may be used as the material of the first electrode EL1.

When the first electrode EL1 is made of a metal oxide or conductive polymer, it may be formed to be transparent.

The second electrode EL2 may be spaced apart from the first electrode EL1 and face the first electrode EL1. The second electrode EL2 may be applied with no voltage or be grounded.

The second electrode EL2 may have substantially the same area and shape as those of the first electrode EL1. For example, the second electrode EL2 may have a rectangular shape including first to fourth sides S1, S2, S3, and S4 that respectively correspond to the first to fourth sides S1, S2, S3, and S4 of the first electrode EL1. The first and third sides S1 and S3 may be parallel sides which extend in the x-axis direction and face each other. The second and fourth sides S2 and S4 may be parallel sides which extend in the y-axis direction and face each other.

The second electrode EL2 may be formed of conductive material in the same manner as that of the first electrode EL1. That is, the second electrode EL2 may be an electrode having a predetermined resistance, and be formed of various kinds of material. The second electrode EL2 may be formed of conductive material, for example, metal, a metal oxide, or a conductive polymer. The first and second electrodes EL1 and EL2 may be made of the same material or different materials.

The material of the second electrode EL2 may be changed in various ways depending on the kind of device employing the touch sensor TS. For example, when the touch sensor TS is employed in a display, the second electrode EL2 may be made of transparent material.

In the embodiment of the present disclosure, the second electrode EL2 may be particularly made of a metal oxide. In another embodiment of the present disclosure, the second electrode EL2 may be made of a conductive polymer. The metal oxide and the conductive polymer are the same as those in the above-description of the first electrode EL1.

The piezoelectric element PZ is provided corresponding to the touch region and disposed between the first electrode EL1 and the second electrode EL2. The piezoelectric element PZ may be a dielectric substance in which dielectric polarization is easily induced by application of mechanical stress. The piezoelectric element PZ may generate a voltage by physical deformation or external pressure.

The piezoelectric element PZ may be formed in an integrated shape, in other words, into a single body, or a plurality of piezoelectric elements PZ may be provided. When a plurality of piezoelectric elements PZ are provided, the number of piezoelectric elements PZ may be determined within a range in which locations of touches of the user can be distinguished. In the case where it is required to precisely distinguish locations of touches of the user, the number of piezoelectric elements PZ may be increased. In the case where it is required to roughly distinguish locations of touches of the user, the number of piezoelectric elements PZ may be reduced.

In the embodiment of the present disclosure, when a plurality of piezoelectric elements PZ are provided, the piezoelectric elements PZ may be provided corresponding to the sensing regions SA and, particularly, provided corresponding to the respective sensing regions SA in a one-to-one fashion. In this case, the number of piezoelectric elements PZ may correspond to that of the sensing regions SA. The piezoelectric elements PZ may be arranged in a form of a matrix including a row extending in the x-axis direction and a column extending in the y-axis direction according to the arrangement of the sensing regions SA so that a location of a touch of the user can be easily determined using coordinates of the row and the column. In another embodiment of the present disclosure, the piezoelectric element PZ may be provided in a one-to-many ratio relative to the sensing regions SA, and vice-versa.

In an embodiment of the present disclosure, in the case of a touch sensor including a plurality of piezoelectric elements PZ, two adjacent piezoelectric elements PZ may be spaced apart from each other and electrically insulated from each other. Although, in FIG. 1C, space between the piezoelectric elements PZ is expressed as being empty space, it is not limited to this. An insulator INS may be provided between the piezoelectric elements PZ. The insulator INS may be made of various materials. For example, the insulator INS may be made of a silicon oxide or silicon nitride. Alternatively, the insulator INS may be made of an insulating polymer.

The material of the piezoelectric element PZ is not limited to a special material, so long as it is able to generate a voltage by physical deformation or external pressure. Examples of the material of the piezoelectric element PZ may include polyvinylidenefluoride, polyvinylidenefluoride derivatives, a copolymer including polyvinylidene fluoride, and so forth. Furthermore, examples of the material of the piezoelectric element PZ may include α-AlPO4 (berlinite), α-SiO2 (quartz), LiTaO3, LiNbO3 SrxBayNb2O8, Pb5-Ge3O11, Tb2(MoO4)3, LiB4O7, CdS, ZnO, Bi12SiO20, Bi12GeO20, AlN (aluminum nitride), PMN-PT (lead magnesium niobate-lead titanate), BaTiO3, KTaO3, KNbO3, NaNbO3, etc.

In the embodiment of the present disclosure, the piezoelectric element PZ may be made of PVDFTrFE (Polyvinylidenefluoride-trifluoroethylene).

In the embodiment of the present disclosure, the electrode pads may be provided in various forms.

Referring to FIG. 1A, the electrode pads may be formed of three electrode pads. In this case, the electrode pads may include an origin electrode pad PDo which is provided on one of the corners of the first electrode EL1, an x electrode pad PDx which is disposed at a position spaced apart from the origin electrode pad PDo in the x-axis direction, and a y electrode pad PDy which is disposed at a position spaced apart from the origin electrode pad PDo in the y-axis direction. The origin electrode pad PDo may be disposed at a position corresponding to the origin, the x electrode pad PDx may be disposed at a position corresponding to the end on the x-axis, and the y electrode pad PDy may be disposed at a position corresponding to the end on the y-axis.

Referring to FIGS. 1B, 1C, and 2A to 2C, the electrode pads may be provided corresponding to the sides of the first electrode EL1. In this case, the electrode pads may include first electrode pads PD1 which are arranged on the first side S1 of the first electrode EL1 in the x-axis direction, and second electrode pads PD2 which are arranged on the second side S2 of the first electrode EL1 in the y-axis direction.

In the embodiment of the present disclosure, the first electrode pads PD1 may be provided on a side of the first electrode EL1 and arranged along the first side S1 of the first electrode EL1 in the x-axis direction. The number of first electrode pads PD1 may correspond to the number of columns of the sensing regions SA in a one-to-one fashion. However, the number of first electrode pads PD1 is not limited to this. For example, the number of first electrode pads PD1 may be greater than the number of columns of the sensing regions SA or less than it.

The second electrode pads PD2 may be provided on another side of the first electrode EL1. In the embodiment of the present disclosure, the second electrode pads PD2 may be provided along the second side S2 of the first electrode EL1. Thereby, the second electrode pads PD2 may be arranged in a direction interesting the direction in which the first electrode pads PD1 are arranged, that is, in the y-axis direction. The number of second electrode pads PD2 may correspond to the number of rows of the sensing regions SA in a one-to-one fashion. However, the number of second electrode pads PD2 is not limited to this. For example, the number of second electrode pads PD2 may be greater than the number of rows of the sensing regions SA or less than it.

Each of the electrode pads, that is, the origin electrode pad PDo, the x electrode pad PDx, the y electrode pad PDy, the first electrode pads PD1, and the second electrode pads PD2, may be made of material having high conductivity. For example, the electrode pads may be made of metal. Examples of the metal may include gold (Au), silver (Ag), platinum (Pt), copper (Cu), nickel (Ni), tungsten (W), titanium (Ti), an alloy thereof, etc. Each of the electrode pads may be formed of a single or multilayer film including at least one of the metals.

The electrode pads may be coupled to a sensing unit SP through respective connection wires CL1 and CL2.

The sensing unit SP may be coupled to the first electrode EL1 and the second electrode EL2 through the electrode pads. In detail, as shown in FIG. 1A, the first electrode EL1 may be coupled to the sensing unit SP through the origin electrode pad PDo, the x electrode pad PDx, and the y electrode pad PDy. As shown in FIGS. 1B and 1C, the first electrode EL1 may be coupled to the sensing unit SP through the first electrode pads PD1 and the second electrode pads PD2.

The sensing unit SP may sense a change in voltage by the piezoelectric elements PZ when a touch of the user is made. A load resistance (not shown) may be disposed in the sensing unit SP between the first electrode EL1 and the second electrode EL2.

The first connection wire CL1, which connects the first electrode EL1 to the sensing unit SP through the electrode pads, may be provided between the first electrode EL1 and the sensing unit SP. Furthermore, the second connection wire CL2 may be provided between the second electrode EL2 and the sensing unit SP. Although in the drawings each of the first and second connection wires CL1 and CL2 is illustrated as being formed of a single wire for the sake of explanation, the present disclosure is not limited to this, and it may be formed of a plurality of wires depending on the number of electrode pads.

In the embodiment of the present disclosure, the touch of the user may be made on a surface corresponding to the first electrode EL1 (that is, on an upper surface of the first electrode EL1 or on an upper surface of another element that is provided on the first electrode EL1). In this case, the first electrode EL1 may be disposed between the user and the second electrode EL2.

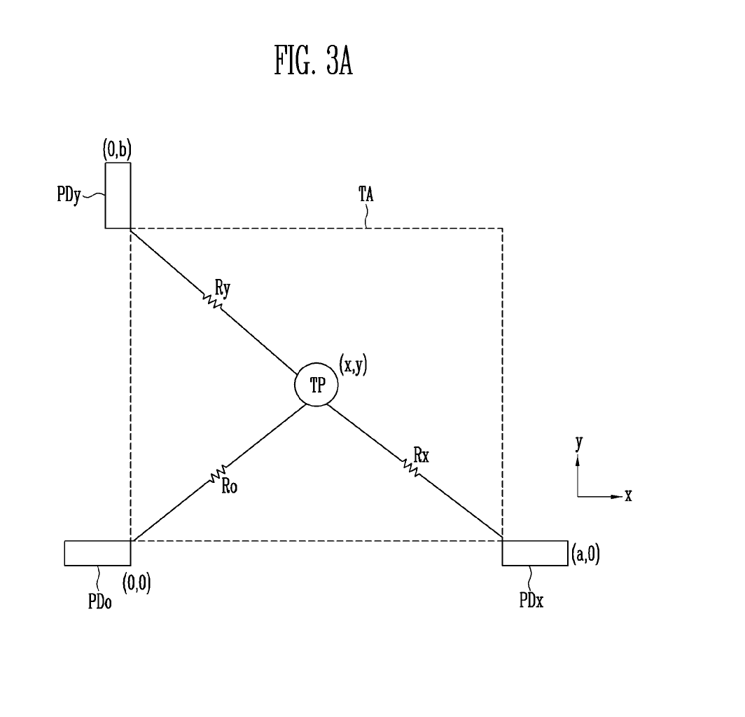

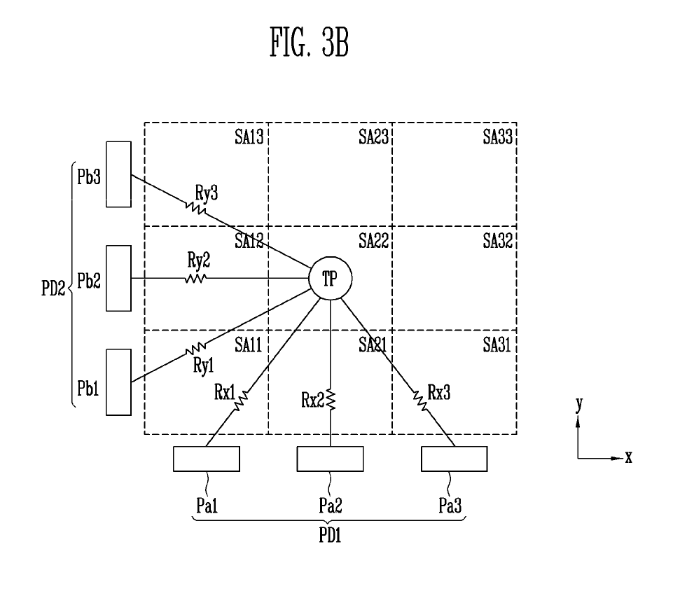

FIGS. 3A and 3B are conceptual views illustrating the principle of sensing the location of a touch of the user for the touch sensor according to the embodiment of the present disclosure. In detail, FIG. 3A is a conceptual view illustrating the principle of sensing the location and/or intensity of a touch of the user for the touch sensor shown in FIG. 1A. FIG. 3B is a conceptual view illustrating the principle of sensing the location and/or intensity of a touch of the user for the touch sensor shown in FIGS. 1B and 1C.

First, a method of sensing a touch of the user will be described with reference to FIGS. 1A and 3A.

In the present embodiment, it is assumed that the location of the origin electrode pad PDo is O (0, 0), the location of the x electrode pad PDx is A (a, 0), the location of the y electrode pad PDy is B (0, b), and the location of a point at which the touch of the user is made is TP (x, y).

When the touch of the user is made, touch pressure is generated in a direction from the first electrode EL1 to the second electrode EL2 by the touch of the user.

Then, the first electrode EL1 may be pressed downward and thus curved toward the second electrode EL2. Thereby, a voltage change ΔV may be caused on a piezoelectric element PZ corresponding to the touch point TP. The voltage change ΔV may be sensed by the electrode pads. When voltage changes that are applied to the origin electrode pad PDo, the x electrode pad PDx, and the y electrode pad PDy respectively refer to ΔV₀, ΔVₓ, and ΔV_{y}, x and y coordinates of the touch point TP may be obtained as follows, using the values of ΔV₀, ΔVₓ, and ΔV_{y} and the following equation.

In the embodiment of the present disclosure, given the fact that the resistance increases as the distance increases, the following equation 1 is satisfied. In the drawing, reference characters Ro, Rx, and Ry respectively denote resistances from the touch point TP to the origin electrode pad PDo, the x electrode pad PDx, and the y electrode pad PDy.

$$\frac{\sqrt{{( x - a )}^{2} + {y}^{2}}}{\sqrt{{x}^{2} + {y}^{2}}} = \frac{Δ {V}_{O}}{Δ {V}_{x}} , \\ \frac{\sqrt{{x}^{2} + {( y - b )}^{2}}}{\sqrt{{x}^{2} + {y}^{2}}} = \frac{Δ {V}_{O}}{Δ {V}_{y}} \qquad [ Equation 1 ]$$

Measured values of ΔV₀, ΔVₓ, and ΔV_{y} are substituted for corresponding variables of Equation 1. When ΔV₀/Δₓ refers to k₁ and ΔV₀/ΔV_{y} , refers to k₂, the following equation 2 is satisfied. The x and y coordinates of the touch point TP may be obtained by calculating the equation 2.

$$\frac{Δ {V}_{o}}{Δ {V}_{x}} = {k}_{1} , \\ \frac{Δ {V}_{o}}{Δ {V}_{y}} = {k}_{2} , \\ ( {k}_{1}^{2} - 1 ) {x}^{2} + 2 ax - {a}^{2} + {k}_{1}^{2} {y}^{2} = 0 , \\ {k}_{2}^{2} {x}^{2} + ( {k}_{2}^{2} - 1 ) {y}^{2} + 2 by - {b}^{2} = 0 \qquad [ Equation 2 ]$$

In the embodiment of the present disclosure, relationship among voltage changes applied to the electrode pads, an x-coordinate and a y-coordinate may be easily determined using a look-up table.

Hereinafter, the method of sensing a touch of the user will be described with reference to FIG. 3B.

In the present embodiment, some of the sensing regions, some of the first electrode pads PD1, and some of the electrode pads PD2 are illustrated. In FIG. 3B, the sensing regions are illustrated as being arranged of a form of a 3×3 matrix and including first to ninth sensing regions SA11, SA12, SA13, SA21, SA22, SA23, SA31, SA32, and SA33 according to the row and column. Also, it is illustrate that corresponding to the sensing regions, the first electrode pads PD1 include first to third pads Pa1, Pa2, and Pa3 along the x-axis direction and the second electrode pads PD2 include fourth to sixth pads Pb1, Pb2, and Pb3 along the y-axis direction.

Referring to FIGS. 1B, 1C, and 3B, when the touch of the user is made, the first electrode EL1 may be pressed downward and thus curved toward the second electrode EL2. Thereby, a voltage change may be caused in at least one piezoelectric element PZ corresponding to the touch point TP. The voltage change may be sensed by at least one of the first electrode pads PD1 and at least one of the second electrode pads PD2. The sensing unit SP may calculate the voltage change sensed by the at least one of the first electrode pads PD1 and the at least one of the second electrode pads PD2 and thus determine the touch point TP.

For example, when the touch is made on the fifth sensing region SA22, a voltage change V is caused in a piezoelectric element PZ corresponding to the fifth sensing region SA22. With regard to the voltage change, a changed voltage is applied to each of the corresponding electrode pads.

When voltage changes that are applied to the first to third pads Pa1, Pa2, and Pa3 arranged in the x-axis direction refer to ΔVx1, ΔVx2, and ΔVx3, each of ΔVx1, ΔVx2, and ΔVx3 may have a value less than the initial voltage change ΔV because the first electrode EL1 is a resistive electrode. That is, first to third resistances Rx1, Rx2, and Rx3 are present between the touch point TP and the respective first to third pads Pa1, Pa2 and Pa3. Voltages applied to the first to third pads Pa1, Pa2, and Pa3 may have different values from the voltage of the touch point TP depending on the first to third resistances Rx1, Rx2, and Rx3. Among the first to third resistances Rx1, Rx2, and Rx3, the second resistance Rx2 closest to the touch point TP is less than the first resistance Rx1 and than third resistance Rx3. Consequently, ΔVx2 of the second pad Pa2 is greater than ΔVx1 of the first pad Pa1 and than ΔVx3 of the third pad Pa3. The sensing unit SP may determine, using the respective voltage values of the pads, the x-axis coordinate of the touch point TP.

In the same manner as the method of determining the x-axis coordinate of the touch point TP, the y-axis coordinate of the touch point TP may be determined. When voltage changes that are applied to the fourth to sixth pads Pb1, Pb2, and Pb3 arranged in the y-axis direction refer to ΔVy1, ΔVy2, and ΔVy3, each of ΔVy1, ΔVy2, and ΔVy3 may have a value less than the initial voltage change ΔV because the first electrode EL1 is a resistive electrode. That is, fourth to sixth resistances Ry1, Ry2, and Ry3 are present between the touch point TP and the respective fourth to sixth pads Pb1, Pb2, and Pb3. Voltages applied to the fourth to sixth pads Pb1, Pb2, and Pb3 may have different values from the voltage of the touch point TP depending on the fourth to sixth resistances Ry1, Ry2, and Ry3. Among the fourth to sixth resistances Ry1, Ry2, and Ry3, the fifth resistance Ry2 closest to the touch point TP is less than the fourth resistance Ry1 and than sixth resistance Ry3. Consequently, ΔVy2 of the fifth pad Pb2 is greater than ΔVy1 of the fourth pad Pa1 and than ΔVy3 of the sixth pad Pa3. The sensing unit SP may determine, using the respective voltage values of the pads, the y-axis coordinate of the touch point TP.

Although an example in which a touch is made only in the fifth sensing region SA22 and a voltage change is caused only in the piezoelectric element PZ corresponding to the fifth sensing region SA22 has been illustrated in the above-description, the embodiment of the present disclosure is not limited to this example. For example, in the case where the area with which the touch of the user is made is relatively large or the touch of the user is made at two or more points, voltage changes may be caused in piezoelectric elements PZ corresponding to two or more sensing regions. In this case, the sensing unit SP may determine a point at which the voltage change is largest as a touch point or determine two or more points as touch points. In the case where simultaneous multiple touches are made rather than a single touch, they may be analyzed using a well-known method for processing an overlapped signal.

In the embodiment of the present disclosure, relationship among voltage changes applied to the first electrode pads PD1 and the second electrode pads PD2, the x-coordinate and the y-coordinate may be easily determined using the look-up table.

The touch sensor according to the embodiment of the present disclosure is able to determine the x-coordinate and the y-coordinate of the location of the touch of the user and also determine a displacement of the touch point by the user and the intensity with which the user presses when the touch is made.

The displacement of the touch point by the user may be calculated using coordinates obtained as a function of time. For example, coordinates obtained at a first time and coordinates obtained at a second time may be separately calculated and, based on this, the displacement of the touch point between the first time and the second time may be calculated. Moreover, using data about the displacement, additional data about a movement distance, a movement speed, a movement direction, a movement angle, etc. of the touch point may be calculated. These pieces of data may be used in various forms.

In the embodiment of the present disclosure, the intensity of the touch of the user may be calculated using a difference in extent between voltage changes applied to the first electrode pads PD1 and the second electrode pads PD2. When the intensity of the touch of the user is low, the voltage change caused in the piezoelectric element PZ is relatively small. When the intensity of the touch of the user is high, the voltage change caused in the piezoelectric element PZ is relatively large. Therefore, the intensity of the touch can be easily calculated using the voltage change. Furthermore, in the embodiment of the present disclosure, determining the intensity of the touch using the voltage change may be easily embodied by forming a look-up table.

Alternatively, the intensity of the touch of the user may be calculated using the number of electrode pads that receive a voltage change. When the intensity of the touch of the user is low, the number of electrode pads that receive the voltage change may be relatively small. When the intensity of the touch is high, the number of electrode pads that receive the voltage change may be relatively large. As such, the intensity of the touch may be easily calculated by counting the number of voltage pads that pertain to the voltage change.

The method of calculating the intensity of the touch may be embodied by a combination of the above-mentioned methods.

Unlike the conventional complex touch panel structures that have been typically introduced, in the touch sensor using the piezoelectric element PZ according to the present disclosure that is capable of determining the location and intensity of a touch, the structure thereof is very simple in which piezoelectric elements PZ that are separated from each other to have cell shapes are present on the lower electrode, and a resistive film is provided on the piezoelectric elements PZ. Furthermore, voltage drop can be measured through a resistive film having potential formed by a cell of a piezoelectric element PZ pertaining to a touch point, whereby the location and intensity of the touch can be analyzed. Therefore, the production cost is markedly reduced, and the location and intensity of the touch can be very accurately measured. Furthermore, the touch sensor is characterized in that analysis of multi-point touches may be facilitated, the resolution may be easily increased by reducing the size of the cells of the piezoelectric elements PZ, and the degree of precision of the touch sensor may be increased by increasing the number of edge electrodes. In addition, there is an advantage in that because a complex logic circuit is not required, the expandability in size of a touch panel is markedly increased. Furthermore, various functions may be provided in such a way that the functions are selectively used depending on the intensity of the touch. Thereby, convenience of use can be greatly enhanced.

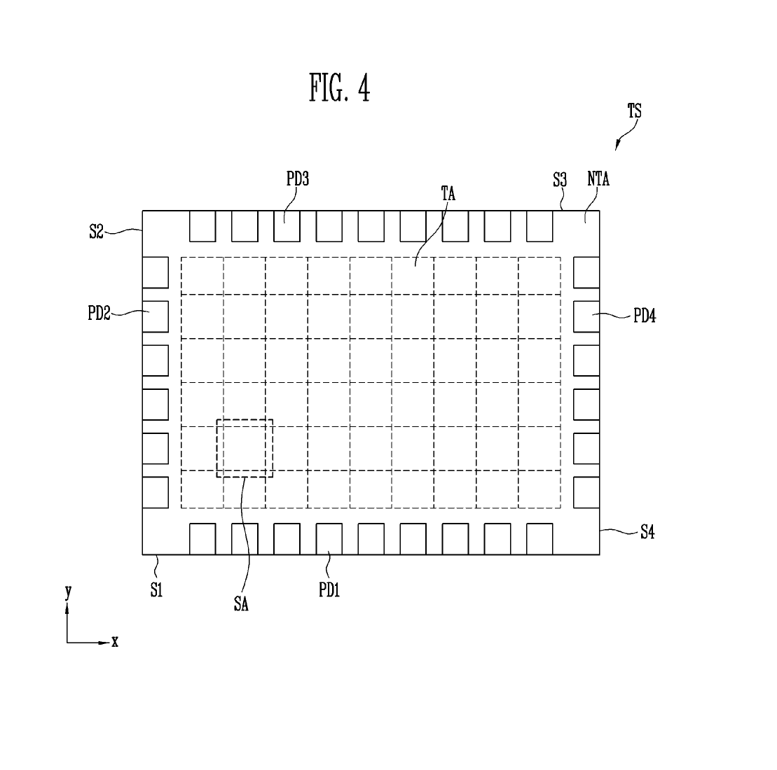

In the touch sensor according to the embodiment of the present disclosure, although electrode pads have been illustrated as being formed on two sides of an electrode, the present disclosure is not limited to this structure. A touch sensor according to another embodiment of the present disclosure may further electrode pads which are formed on the sides of the electrode other than the above-mentioned two sides. FIG. 4 is a plan view showing the touch sensor according to this embodiment of the present disclosure.

In the description of the following embodiment, different parts from those of the preceding embodiment will be mainly explained to avoid redundancy of explanation. Furthermore, in the description of the following embodiment, the same reference numerals are used to designate substantially the same components, and unexplained parts comply with the description of the preceding embodiment.

Referring to FIG. 4, the touch sensor TS according to this embodiment of the present disclosure may include a first electrode EL1, a second electrode (not shown), piezoelectric elements (not shown), and electrode pads. A sensing unit (not shown) is coupled with each of the electrode pads.

The touch sensor TS may include a touch region TA and a non-touch region NTA which is provided on at least one side of the touch area TA. The touch region TA may include a plurality of sensing regions SA. In the present embodiment, for example, the touch region TA is illustrated as being formed of 6×9 sensing regions SA.

In the present embodiment, the first electrode EL1 may be an electrode which is provided to a user side and corresponds to a surface that the user touches. The first electrode EL1 may be applied with no voltage. When a touch is made on the first electrode EL1, a voltage generated from the piezoelectric element PZ may be applied thereto. The first electrode EL1 may have a rectangular shape including first to fourth sides S1, S2, S3, and S4. The first and third sides S1 and S3 may be parallel sides which extend in the x-axis direction and face each other. The second and fourth sides S2 and S4 may be parallel sides which extend in the y-axis direction and face each other.

The second electrode may be spaced apart from the first electrode EL1 and face the first electrode EL1. The second electrode may be applied with no voltage or be grounded.

The piezoelectric element PZ is provided within the touch region TA and disposed between the first electrode EL1 and the second electrode.

The touch sensor according to the present embodiment may include first to fourth electrode pads PD1, PD2, PD3, and PD4.

The first electrode pads PD1 and the third electrode pads PD3 may function to sense x-axial location and intensity of a touch of the user when the touch is made.

The first electrode pads PD1 may be arranged along the first side S1 of the first electrode EL1 in the x-axis direction. The third electrode pads PD3 may be arranged along the third side S3 of the first electrode EL1 in the x-axis direction. Each of the number of first electrode pads PD1 and the number of third electrode pads PD3 may correspond to the number of columns of the sensing regions SA in a one-to-one fashion. However, the number of first electrode pads PD1 and the number of third electrode pads PD3 are not limited to this and, for example, each may be greater than the number of the sensing regions SA or less than it.

The second electrode pads PD2 and the fourth electrode pads PD4 may function to sense y-axial location and intensity of a touch of the user when the touch is made.

The second electrode pads PD2 may be arranged along the second side S2 of the first electrode EL1 in the y-axis direction. The fourth electrode pads PD4 may be arranged along the fourth side S4 of the first electrode EL1 in the y-axis direction. Each of the number of second electrode pads PD2 and the number of fourth electrode pads PD4 may correspond to the number of rows of the sensing regions SA in a one-to-one fashion. However, the number of second electrode pads PD2 and the number of fourth electrode pads PD4 are not limited to this and, for example, each may be greater than the number of the sensing regions SA or less than it.

The touch sensor according to the present embodiment having the above-mentioned configuration is able to determine the location and intensity of the touch in the same manner as that of the touch sensor according to the preceding embodiment. FIG. 5 is a schematic equivalent circuit diagram of the touch sensor of FIG. 4. In FIG. 5, the first electrode pads PD1 successively refer to Pa1, Pa2, . . . , and Pa9 along the x-axis. The second electrode pads PD2 successively refer to Pb1, Pb2, . . . , and Pb6 along the y-axis. The third electrode pads PD3 successively refer to Pc1, Pc2, . . . , and Pc6 along the x-axis. The fourth electrode pads PD2 successively refer to Pd1, Pd2, . . . , and Pd6 in the y-axis.

Referring to FIG. 5, when a touch of the user is made, resistances are present between a touch point TP and the first to fourth electrode pads PD1, PD2, PD3, and PD4, and different voltages are applied to the respective electrode pads. Since the first electrode EL1 is a resistive electrode, when the touch is made, among the first to fourth electrode pads PD1, PD2, PD3, and PD4, a voltage change of an electrode pad that is closest to the touch point TP is largest.

For instance, the electrode pad Pa1 among the first electrode pads PD1 arranged in the x-axis direction, and the electrode pad Pc7 among the third electrode pads PD3 may be largest in voltage change applied thereto. Thereby, the sensing unit is able to calculate an x-axis coordinate of the touch point TP. Furthermore, because the resistance between the touch point TP and the electrode pad Pa7 is less than the resistance between the touch point TP and the electrode pad Pc7, a voltage change applied to the electrode pad Pa7 is greater than a voltage change applied to the electrode pad Pc7. Given this, the y-axial location of the touch point may be calculated by comparing the voltage change applied to the electrode pad Pa7 with the voltage change applied to the electrode pad Pc7.

Likewise, the electrode pad Pb2 among the second electrode pads PD2 arranged in the y-axis direction, and the electrode pad Pd2 among the fourth electrode pads PD4 may be largest in voltage change applied thereto. Thereby, the sensing unit is able to calculate a y-axis coordinate of the touch point TP. Furthermore, because the resistance between the touch point TP and the electrode pad Pd2 is less than the resistance between the touch point TP and the electrode pad Pb2, a voltage change applied to the electrode pad Pd2 is greater than a voltage change applied to the electrode pad Pb2. Given this, the x-axial location of the touch point may be calculated by comparing the voltage change applied to the electrode pad Pd2 with the voltage change applied to the electrode pad Pb2.

As described above, in the touch sensor according to the present embodiment, the number of electrode pads that are used to sense the x-axial and y-axial locations is increased, whereby the location of the touch point and the intensity of the touch may be more accurately determined.

In the embodiments of the present disclosure, the touch sensors having the above-mentioned configurations may be provided with an additional component for convenience of manufacture.

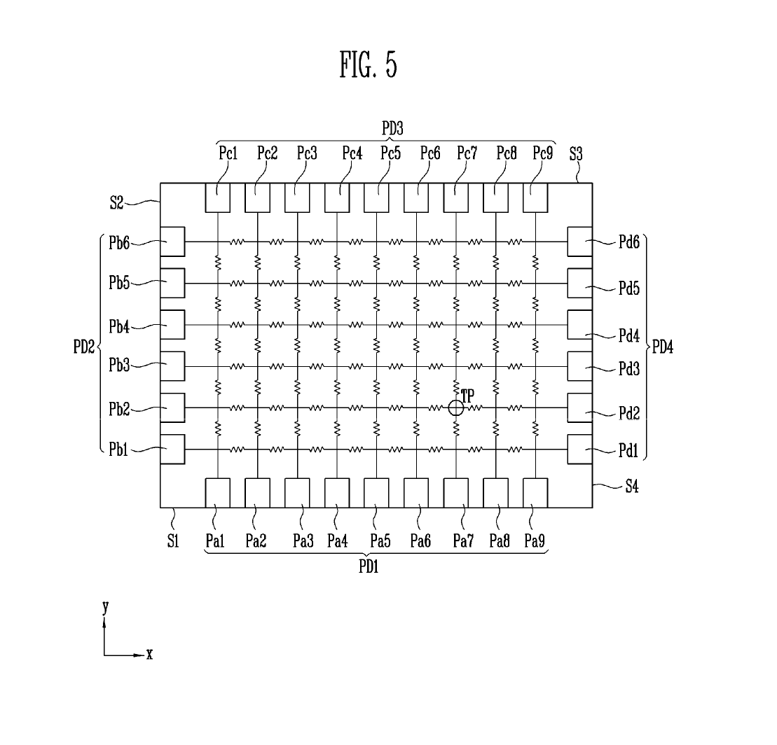

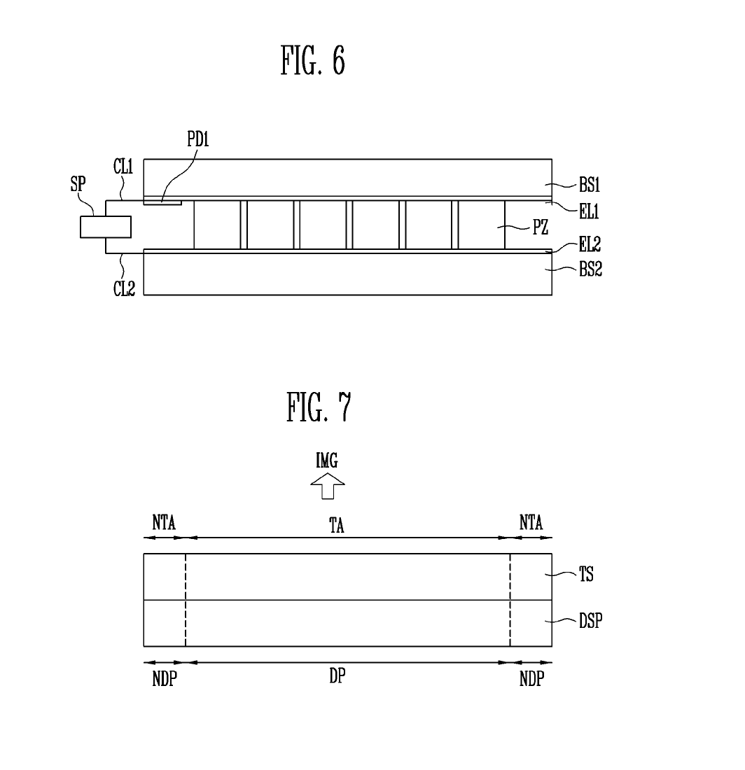

FIG. 6 is a sectional view illustrating a touch sensor provided with two additional base substrates according to an embodiment of the present disclosure.

Referring to FIG. 6, the touch sensor may further include a first base substrate BS1 on which the first electrode EL1 is mounted, and a second base substrate BS2 on which the second electrode EL2 is mounted.

The first base substrate BS1 and the second base substrate BS2 function to support the first electrode EL1 and the second electrode EL2 and may be made of insulation material. The first and second base substrates BS1 and BS2 may be made of transparent material and have flexibility. Particularly, the first base substrate BS1 may have appropriate flexibility and elasticity to apply pressure to the piezoelectric element PZ when a touch of the user is made.

Each of the first and second base substrate BS1 and BS2 may be independently made of polyethylene terephthalate (PET), polycarbonate (PC), polymethylmetaacrylate (PMMA), polyehtylene naphthalate (PEN), polyethersulfone (PES), cyclic olefin copolymer (COC), a triacetylcellulose (TAC) film, a polyvinylalcohol (PVA) film, a polyimide (PI) film, polystyrene (PS), biaxially oriented PS (BOPS, containing K-resin), glass, reinforced glass, or the like. However, the material of each of the first and second base substrates BS1 and BS2 is not limited to this, and other materials may be used.

In the case where the first electrode EL1 is mounted on the first base substrate BS1, the electrode pads (in the drawing, the first electrode pad PD1) may be formed on a surface of the first electrode EL1 that is opposite to the surface thereof on which the first base substrate BS1 is mounted.

In the present embodiment of the present disclosure, the touch sensor that is expressed as that of the preceding embodiments may be employed in other electronic devices, for example, a display.

FIG. 7 is a sectional view illustrating a display using a touch sensor according to an embodiment of the present disclosure.

The display according to the present embodiment may include a display panel DSP which displays an image IMG, and a touch sensor TS which is provided on one surface of the display panel DSP and configured to sense a touch of the user.

In the present embodiment, the touch sensor TS may be provided on a front surface of the display panel DSP on which the image IMG is displayed. Since the touch sensor TS is provided at a position corresponding to the direction in which the image IMG is displayed, it is easy for the user to directly make a touch on the corresponding surface of the display in response to the image IMG and, conversely, it is also easy for the image IMG to respond to the touch of the user.

The display panel DSP is not limited to a special display panel so long as it is able to output an image. The display panel DSP may be provided in various forms, e.g., a liquid crystal display, an electroluminescence display, an electrophoretic display, and an electrowetting display.

The display panel DSP may include a display region DA in which the image is displayed, and a non-display region NDA which is formed on at least one side of the display region DA. In the present embodiment, the touch region TA of the touch sensor TS may be provided at a position corresponding to the display region DA of the display panel DSP. For example, in a plan view, the touch region TA may overlap the display region DA. Furthermore, the non-touch region NTA of the touch sensor TS may overlap the non-display region NDA of the display panel DSP.A touch sensor according to an embodiment of the present disclosure has a structure capable of accurately determining the location of a touch point and the intensity of the touch despite low production cost.

While various exemplary embodiments have been described above, those skilled in the art will appreciate that various modifications, additions and substitutions are possible, without departing from the scope and spirit of the disclosure.

Therefore, the embodiments disclosed in this specification are only for illustrative purposes rather than limiting the technical spirit of the present disclosure. The scope of the present disclosure must be defined by the accompanying claims.

What is claimed is:

1. A touch sensor configured to sense a touch of a user, comprising:
a first electrode;
a second electrode facing the first electrode;
at least one piezoelectric element disposed between the first electrode and the second electrode; and
electrode pads coupled to the first electrode.

2. The touch sensor according to claim 1, further comprising:
a sensing unit coupled to the first electrode and the second electrode and configured to sense a voltage change by the piezoelectric element when a touch of the user is made.

3. The touch sensor according to claim 1,
wherein the first electrode has a rectangular shape including first to fourth sides, and
wherein the first and third sides extend in an x-axis direction, and the second and fourth sides extend in a y-axis direction.

4. The touch sensor according to claim 3, wherein the electrode pads comprise:
an origin electrode pad provided on one of corners of the first electrode;
an x electrode pad disposed at a position spaced apart from the origin electrode pad in the x-axis direction; and
a y electrode pad disposed at a position spaced apart from the origin electrode pad in the y-axis direction.

5. The touch sensor according to claim 3, wherein the electrode pads comprise first electrode pads arranged on the first side of the first electrode in the x-axis direction, and second electrode pads arranged on the second side of the first electrode in the y-axis direction.

6. The touch sensor according to claim 5, wherein the piezoelectric element comprises a plurality of piezoelectric elements arranged in a matrix having the x-axis direction as a row direction and the y-axis direction as a column direction.

7. The touch sensor according to claim 6, wherein the first electrode pads are provided to one-to-one correspond to the respective columns of the matrix, and the second electrode pads are provided to one-to-one correspond to the respective rows of the matrix.

8. The touch sensor according to claim 5, wherein the electrode pads further comprise third electrode pads provided on the third side facing the first side.

9. The touch sensor according to claim 8, wherein the third electrode pads are provided to one-to-one correspond to the respective columns of the matrix.

10. The touch sensor according to claim 5, wherein the electrode pads further comprise fourth electrode pads provided on the fourth side facing the second side.

11. The touch sensor according to claim 10, wherein the fourth electrode pads are provided to one-to-one correspond to the respective rows of the matrix.

12. The touch sensor according to claim 1, wherein the second electrode is grounded.

13. The touch sensor according to claim 1, wherein the first electrode is provided between the user and the second electrode.

14. The touch sensor according to claim 1, wherein the piezoelectric element comprises a plurality of piezoelectric elements, the touch sensor further comprising:
an insulator provided between two adjacent piezoelectric elements.

15. The touch sensor according to claim 1, wherein the piezoelectric element includes a piezoelectric polymer material.

16. The touch sensor according to claim 15, wherein the piezoelectric polymer material includes polyvilylidenefluoride or a derivative thereof.

17. The touch sensor according to claim 1, wherein each of the first electrode and the second electrode is made of a transparent metal oxide film.

18. The touch sensor according to claim 17, wherein each of the first electrode pad and the second electrode pad is made of metal.

19. The touch sensor according to claim 1, further comprising:
a first base substrate mounted with the first electrode; and
a second base substrate mounted with the second electrode.

20. A display comprising:
a display panel configured to display an image; and
a touch sensor provided on a front surface of the display panel and configured to sense a touch of a user, the touch sensor comprising:
a first electrode;
a second electrode facing the first electrode;
at least one piezoelectric element disposed between the first electrode and the second electrode; and
a plurality of electrode pads coupled to the first electrode.
